(19) United States
(12) Patent Application Publication
(10) Pub. No.: US 2012/0256385 A1
(43) Pub. Date: Oct. 11, 2012

(54) Traffic Cone Dolly

(76) Inventor: John J. Pujol, Redondo Beach, CA (US)

(21) Appl. No.: 13/081,402

(22) Filed: Apr. 6, 2011

(51) Int. Cl. B62B 3/00; B62B 3/10

(52) U.S. Cl. 280/79.11

(57) ABSTRACT

The invention is a dolly that may assist a user in moving one or more cones from one location to another. The cone dolly is stackable when it is not in use and may contain handles. Users can utilize the wheels on the bottom of the dolly to push one or more cones from one location to another or utilize the handles within the body of the dolly to carry the dolly when it is not in use.

### FIELD OF THE INVENTION

The present invention relates to a multi-wheeled dolly. Specifically, this invention relates to a traffic cone dolly that assists a user in moving traffic cones from one location to another. The traffic cone dolly is stackable on a traffic cone for easy storage when it is not in use.

### BACKGROUND

For decades, wheeled dollies have been used to help users move various types of goods, such a garbage cans or furniture, from one location to another. Typically, dollies have a flat surface that has four or five wheels attached to the bottom. The flat surface is typically a square, rectangle, or equilateral polygon. In addition to flat dollies, several dollies have been developed to engage with specific types of goods, such as a refuse container. For example, U.S. Pat. No. 5,074,572 issued to Delmerico, discloses a wheeled refuse container dolly, wherein the dolly has a raised rectangular piece on the surface of the dolly. The raised rectangular piece, or the male piece, fits snugly within a depression on the bottom of a refuse container. This snug fit restricts the movement of the refuse container while the user pushes or pulls the dolly and container assembly.

Regarding dollies that are stackable, United States Published Patent Application Number 2009/0267313, filed by Kalajyan, discloses a dolly that matingly stacks with other dollies when not in use.

Importantly, neither the Delmerico Patent nor the Kalajyan Published Patent Application discloses a dolly that is adapted to have traffic cones stacked on it and wherein the dolly also is able to be stacked on a traffic cone. Thus, what is needed is a multi-wheeled dolly that is able to carry a heavy load of traffic cones, transport the traffic cones over an uneven ground, and stack on a traffic cone when not in use.

### SUMMARY OF THE INVENTION

To minimize the limitations in the prior art, and to minimize other limitations that will become apparent upon reading and understanding the present specification, the present invention relates to a multi-wheeled traffic cone dolly. The dolly preferably has a hole in the middle of its base so that it is able to stack on top of a traffic cone when not in use. The dolly may also have integrated handles that allow a user to more easily transport when not in use. The hole of the traffic cone dolly may include protrusions, divots, or teeth to assist in stacking the dolly on a traffic cone.

One embodiment of the invention is a multi-wheeled traffic cone dolly comprising: a platform; and a plurality of wheels. The wheels may be on a bottom side of the platform such that the platform is rollably supported by the plurality of wheels. The top side of the platform may have a proximally slanted ring shaped protrusion rising from the top side of the platform. The exterior surface of the proximally slanted ring shaped protrusion may be adapted to engage (loosely or matingly) with an interior surface of a traffic cone to enable the traffic cone to be rollably moved by the multi-wheeled traffic cone dolly. The platform preferably may have a centralized hole. The proximally slanted ring shaped protrusion rising from the top side of the platform may form a lip that is flush with and encircles the centralized hole. The centralized hole and an interior surface of the lip may be adapted to matingly engage with an exterior surface of a stationary or standing traffic cone such that the multi-wheeled traffic cone dolly might encircle the stationary traffic cone if the dolly is placed onto a cone. The platform preferably also includes one or more handle holes, which are adapted for grasping and carrying the traffic cone dolly when not in use. The interior surface of the lip may be comprised of a plurality of protrusions that releasably engage with the exterior surface of the traffic cone when the multi-wheeled traffic cone dolly is placed on and encircles the traffic cone. The plurality of wheels may be adapted to roll over uneven and rough terrain. Preferably the platform is substantially circular. The traffic cone dolly is preferably used to transport more than one traffic cone. The traffic cone dolly is preferably stored by stacking it on top of the stationary traffic cone.

Another embodiment of the invention is a multi-wheeled traffic cone dolly comprising: a substantially circular platform and a plurality of wheels. The plurality of wheels, preferably five wheels, may be on a bottom side of the platform such that the platform is rollably supported by the plurality of wheels. The platform may have a centralized hole and one or more handle holes. The top side of the platform may be a centered and proximally slanted ring shaped lip rising from the top side of the platform. The proximally slanted ring shaped lip may be flush with and encircles the centralized hole. The centralized hole and an interior surface of the lip may be adapted to matingly engage with an exterior surface of the stationary traffic cone when the multi-wheeled traffic cone dolly is placed on and encircles the stationary traffic cone. The exterior surface of the proximally slanted ring shaped lip may be adapted to engage (loosely or matingly) with an interior surface of a traffic cone to be transported to enable the traffic cone to be rollably moved by the multi-wheeled traffic cone dolly. The handle holes may be adapted for grasping and carrying the traffic cone dolly when not in use. The interior surface of the lip is preferably comprised of a plurality of protrusions that ring the interior surface of the lip and releasably engage with the exterior surface of the stationary traffic cone when the multi-wheeled traffic cone dolly is placed on and encircles the stationary traffic cone. The multi-wheeled traffic cone dolly may have a plurality of shock absorbers or other ride smoothing devices. The plurality of wheels may be preferably adapted to roll over uneven and rough terrain. The plurality of wheels is preferably rounded and arched to reduce a wheel surface area contact with the ground. The multi-wheeled traffic cone dolly may be adapted to transport a stack of traffic cones. The multi-wheeled traffic cone dolly may be stored by stacking it on top of a stationary traffic cone.

The plurality of wheels may be constructed of a soft rubber material such that the plurality of wheels may be more forgiving when the plurality of wheels may encounter pebbles and other obstructions. The plurality of wheels may include at least five wheels such that the plurality of wheels provides greater support and balance than a multi-wheeled dolly that only provides four wheels.

It is a purpose of the present invention to have a raised ring portion of the dolly that mimic the shape of a traffic cone so that one or more traffic cones is held securely by preventing the traffic cones that are being transported from sliding off of the platform and by keeping the traffic cones centered. A properly centered load of traffic cones is the key to easily transporting the traffic cones from one location to another. Alternatively, the raised portion may matingly engage with cone.

It is an object of the invention to provide an inexpensive and easy to use dolly that can transport a large number of traffic cones over uneven pavement. Using the dolly instead of carrying the cones will reduce injuries caused from carrying the very heavy cones. The dolly will also increase the efficiency of road work by decreasing the number of trips a user would normally need to make to deploy the cones and other devices along a road or footpath.

Another advantage of this device is to minimize the risk of a user carrying cones and other devices around automotive traffic. Presently, a user may carry a pile of cones alongside a road or footpath where heavy traffic passes merely feet away, especially when a truck is unable to maneuver within the construction area to carry cones and other devices to the construction site. By providing a dolly to carry the cones and other devices, the user may focus on maneuvering next to traffic while directing a stack of cones on the dolly instead of lifting the heavy materials. The invention helps to expedite the process of moving cones and other devices from one location to another and further enhances the user's safety.

It is an object of the present invention to overcome the limitations of the prior art. Current dollies are not adapted to specifically transport traffic cones, which mean that when they are used to transport traffic cones, the cones easily fall off and the dolly is hard to maneuver. The present invention over comes these limitations.

It is another object of the invention to provide a traffic cone dolly that may be easily and securely stored on a stationary traffic cone, or a stack of traffic cones. In this manner the dolly will be easy to find in order to transport the cones.

### BRIEF DESCRIPTION OF THE DRAWINGS

FIG. 1 is an illustration of a perspective top view of one embodiment of the traffic cone dolly.

FIG. 2 is an illustration of a side view of one embodiment of the traffic cone dolly.

FIG. 3 is an illustration of a perspective bottom view of one embodiment of the traffic cone dolly with protrusions.

FIG. 4 is an illustration of a perspective view of one embodiment of the traffic cone dolly resting on a traffic cone.

FIG. 5 is an illustration of a perspective view of one embodiment of a traffic cone resting on the traffic cone dolly.

### DETAILED DESCRIPTION OF THE DRAWINGS

In the following detailed description of the preferred embodiment, reference is made to the accompanying drawings that form a part hereof, and in which is shown, by way of illustration, a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

“Traffic cone” or “cone” refers to a standard heavy rubber or plastic conical device that is used to direct traffic. The standard traffic cone used in the United States weighs approximately 10 pounds. Although traffic cones are not an element of the invention, the invention is designed to be used with traffic cones. The cones are generally bright orange or yellow with reflective tape wrapped around portions of the exterior. Frequently, a significant number of cones may be required to properly direct vehicle traffic, and a typical road worker cannot carry more than 3 or 4 cones at a time without risking shoulder and back injury. The traffic cones may also be referred to as channelizers, traffic pylons, road cones, highway cones, safety cones, construction cones, and witches' hats.

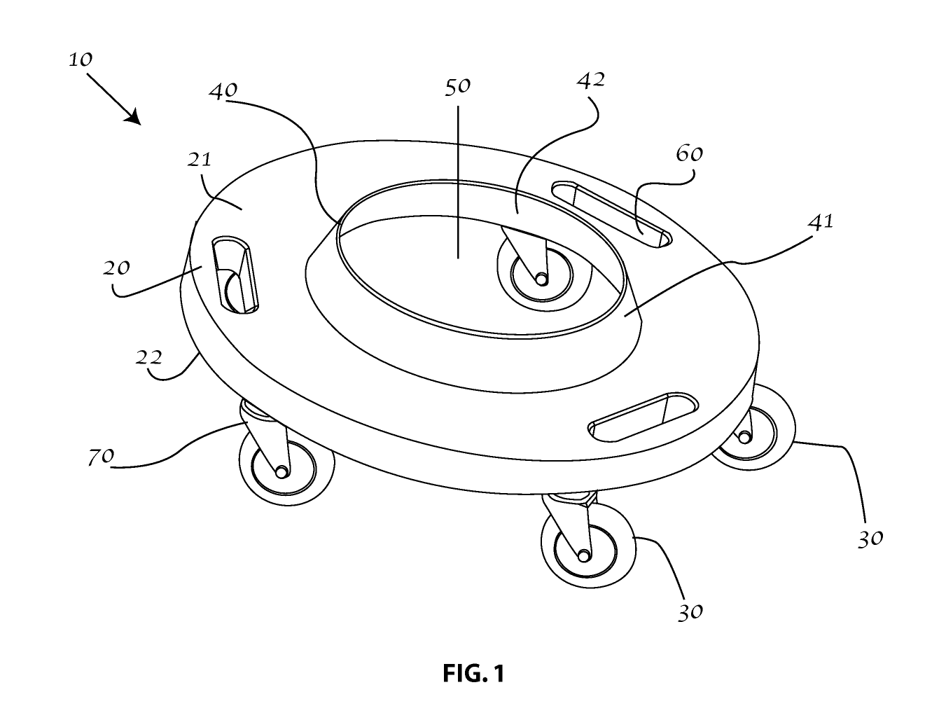

FIG. 1 is an illustration of a perspective top view of one embodiment of the traffic cone dolly. The multi-wheeled traffic cone dolly 10 may include a platform 20, top side 21, bottom side 22, wheels 30, a proximally slanted ring shaped protrusion 40, exterior surface 41, interior proximal surface 42, a hole 50, handle holes 60, and caster forks 70. As shown in FIG. 1, the platform 20 is substantially parallel to the ground and supported evenly and rollably by wheels 30 while the multi-wheeled dolly 10 is in use. The wheels are attached to a bottom side 22 of platform 20. The wheels 30 allow the multi-wheeled traffic cone dolly 10 to be easily rolled from one location to another. The platform 20 is preferably constructed from hard plastic, but it may be made from any natural or man-made material including, but not limited to, wood, metal, a polymer, or a composite material. The platform preferably is able to support a significant number (anywhere between three to several dozen) of traffic cones that are stacked on top of it. The platform 20 may also have a textured surface to improve the grip between the platform 20 and the first traffic cone that is stacked on it. Although the platform 20 may be used to rest objects on top of the multi-wheeled traffic cone dolly 10 without engaging the item with proximally slanted ring shaped protrusion 40, preferably the proximally slanted ring shaped protrusion 40, is engaged.

As shown in FIG. 1, the proximally slanted ring shaped protrusion 40 rises from the top side 21 of platform 20. The exterior surface 41 of said proximally slanted ring shaped protrusion 40 is adapted to engage with an interior surface of a traffic cone to keep the traffic cone centered on the platform and enable said traffic cone to be rollably moved by the multi-wheeled traffic cone dolly 10. The ring shaped protrusion 40 is preferably inwardly or proximally slanted. In this manner, the ring shaped protrusion may substantially conform to an interior surface of a traffic cone, which also slants inwardly or proximally. The base or bottom of the traffic cone rests on platform 40 and is substantially prevented from sliding off by the proximally slanted ring shaped protrusion 40. As shown in FIG. 1, the proximally slanted ring shaped protrusion 40 protrudes far enough away from platform 20 to extend substantially into an interior of the traffic cone to securely hold the traffic cone. Although the proximally slanted ring shaped protrusion 40 may tightly fit with a traffic cone, preferably it does not, and instead acts as a guide to center the traffic cone. The ring shaped protrusion 40 is preferably proximally slanted, as shown in FIG. 1, but the ring shaped protrusion 40 may be distally slanted or even perpendicular to the platform 20 without deviating from the scope of the invention.

The ring shaped protrusion 40 may be constructed with the same material that is used to construct the platform 20, or a material with a greater surface friction maybe used. When a material that has more friction is used, the stability between the multi-wheeled traffic cone dolly 10 and other objects that engage with the outside of the ring shaped protrusion 40 is also increased because if the cone slides on the platform, it will not continue to slide up and over the ring shaped protrusion 40. Although only one protrusion is shown, multiple protrusions may be used if multiple stacks of cones are placed on the platform. The ring shaped protrusion 40 is preferably at the center of the platform 20 and keeps the traffic cone, or stack of traffic cones being transported, centered on the platform. The ring shaped protrusion 40 also keeps the cones from sliding off.

FIG. 1 shows the dolly 10 as substantially circular, but the dolly 10 may be any shape so long as it can support a stack of traffic cones.

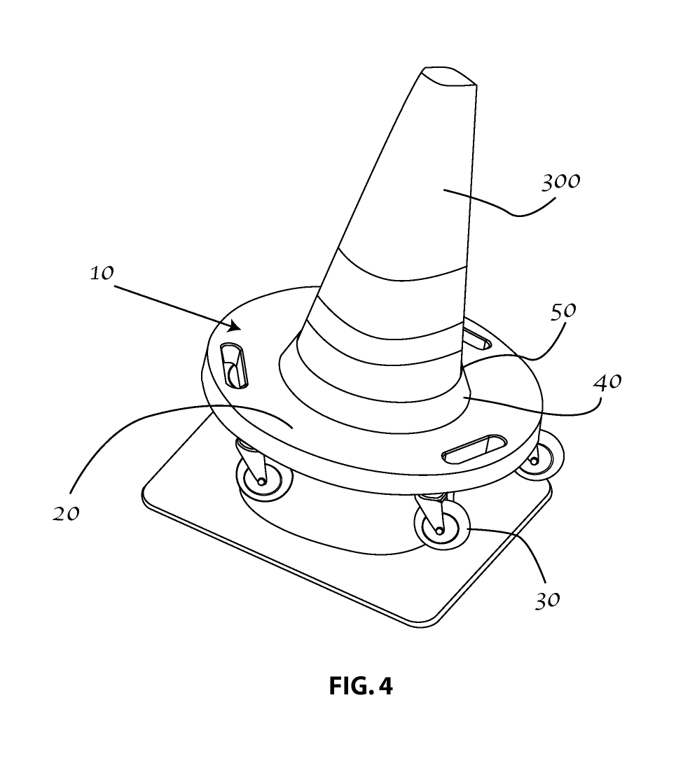

Additionally, FIG. 1 shows that the dolly 10 has a hole 50. FIG. 1 shows that the proximally slanted ring shaped protrusion 40 forms a lip that is flush with and encircles said hole 50. The hole 50 is preferably centralized and an interior surface 42 of the lip are adapted to matingly engage with an exterior surface of said traffic cone such that said multi-wheeled traffic cone dolly encircles the traffic cone (as shown in FIG. 4), or any conically slanted object. The hole 50 may be offset from the center of the multi-wheeled traffic cone dolly 10 without deviating from the scope of the invention.

The hole 50 allows traffic cones, poles, arms, or other object to pass through the dolly 10. Because several types of objects may pass through the hole 50, the utility of the hole 50 is expansive is not limited to the preferred use of engaging with a traffic cone. The hole 50 may also allow dolly 10 to be stacked on top of a traffic cone when one or more traffic cones are stacked on top of the cone dolly 10.

The hole 50 also lessens the weight of the multi-wheeled traffic cone dolly 10 so that when the user needs to carry the multi-wheeled traffic cone dolly 10, the user will not have to strain as greatly as if there was no hole 50. The hole 50 allows the dolly 10 to be stored on a stationary traffic cone, or stack of traffic cones, or any pole type structure.

The wheels 30 are preferably made of a soft rubber so that the wheels 30 can mitigate the impact of some of the negative road conditions that the multi-wheeled traffic dolly 10 may encounter. As shown in FIG. 1, the wheels 30 are arched to reduce the amount of surface of the wheels 30 that are in contact with the ground. This also helps the wheels 30 overcome obstacles, such as pebbles. A flat wheel has the tendency to trap pebbles, and may halt the progress of the wheel entirely. The tapered or arched wheel 30 helps deflect rather than trap any pebbles or other surface irregularities, which prevents the wheel from locking up.

The platform 20 may also have handle holes 60. The handle holes 60 are preferably adapted to allow a user's fingers to pass through the handle holes 60 and firmly grasp dolly 10. Although the handle holes 60 are shown as holes, it should be understood that handle holes 60 could be notches, indentations, or other structures for grasping firmly the dolly 10. As shown in FIG. 1, the dolly 10 preferably has three handle holes 60 that completely pass through the platform 20.

The wheels 30 preferably have caster forks 70, which are fully swivelable and allow the dolly 10 to roll in any direction. The alignment of the wheels is preferably equidistant from each other so that the weight of the platform 20, cones, and other devices may be distributed equally. In alternate embodiments, any number of wheels may be used in order to create a stable wheel base below the platform 20.

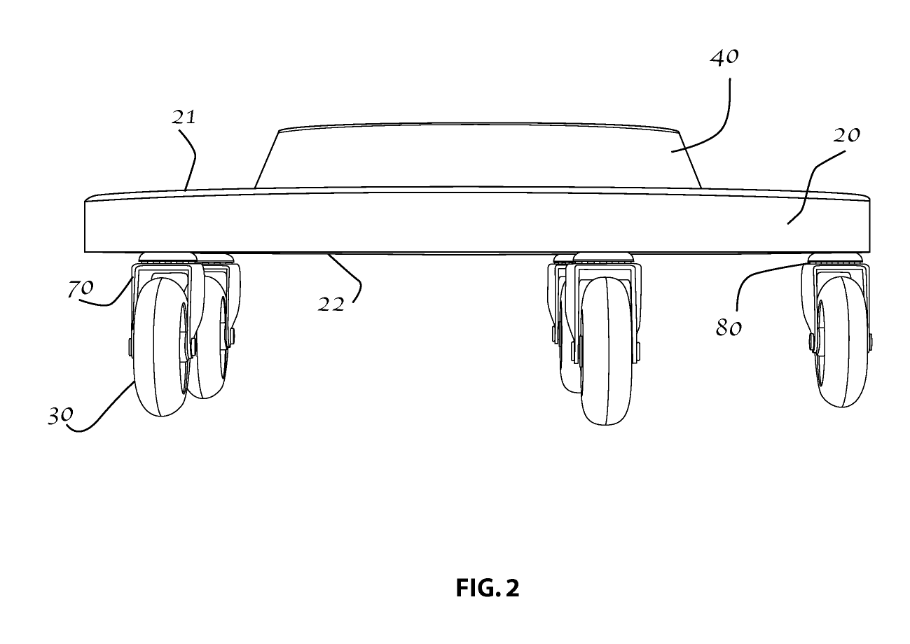

FIG. 2 is an illustration of a side view of one embodiment of the traffic cone dolly. As shown in FIG. 2, the platform 20 is preferably parallel to the ground so that top surface 21 of platform 20 provides a stable surface for a traffic cone. FIG. 2 shows that the castor forks 70 may include a swivel 80, which better allows the dolly 10 to move over uneven pavement.

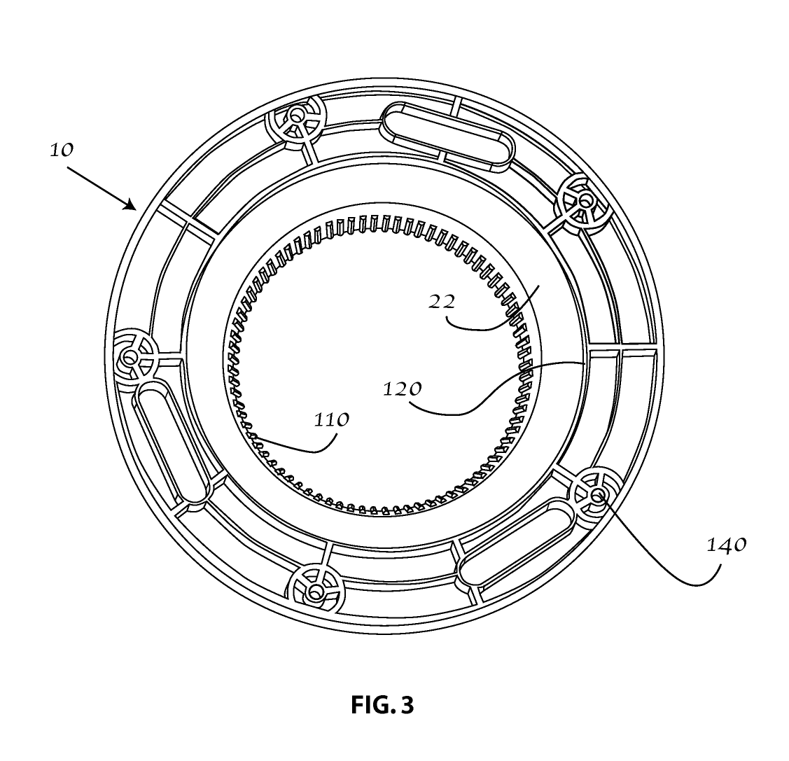

FIG. 3 is an illustration of a perspective bottom view of one embodiment of the traffic cone dolly with protrusions. As shown in FIG. 3, the bottom surface 22 of dolly 10 preferably includes protrusions 110, reinforcement ribs 120, and wheel engagement portions 140. As shown in FIG. 3, the interior surface of the proximally slanted ring shaped protrusion 40 may include a plurality of evenly spaced projections, teeth, nodes, nubs, or protrusions 110. The protrusions 110 releasably engage with the exterior surface of a traffic cone when said multi-wheeled traffic cone dolly 10 is placed on and encircles the traffic cone. The protrusions 110 help prevent the cone dolly 10 from becoming stuck on a cone on which it is placed. The protrusions 110 may also help the cone dolly from twisting when it is stored on a cone. The protrusions 110 may be made from the same material as the platform 120 or a more flexible material, such as a softer polymer, which may distort under the pressure of an exterior surface of a cone. The protrusions may act to decrease the circumference of the hole in order to more efficiently engage with a wider range of cone sizes. The protrusions 110 also help prevent the cone dolly 10 from adhering to the cone itself and, thus, becoming stuck on a cone or a stack of cones. The cone dolly 10 is held snuggly on a stationary cone, in order to prevent the cone dolly 10 from being jarred loose accidentally, but the user may still easily remove the cone dolly 10 from the stationary traffic cone when needed.

The wheel engagement portions 140 are adapted to allow a user to easily remove and insert wheels. In this manner, worn out wheels may be easily replaced or upgraded.

The reinforcement ribs 120 provide strength and support to the platform without adding the additional weight of significantly increasing the thickness of the platform.

FIG. 4 is an illustration of a perspective view of one embodiment of the traffic cone dolly resting on a traffic cone. As shown in FIG. 4, the multi-wheeled traffic cone dolly 10 has proximally slanted ring shaped protrusion 40, which forms a lip around hole 50. FIG. 4 shows how the interior surface 42 of the lip and hole 50 matingly engages with an exterior surface of traffic cone 300 such that the multi-wheeled traffic cone dolly 10 encircles the traffic cone 300. As shown in FIG. 4, the wheels 30 typically do not touch the base of the traffic cone 300 when the cone dolly is stored around a traffic cone.

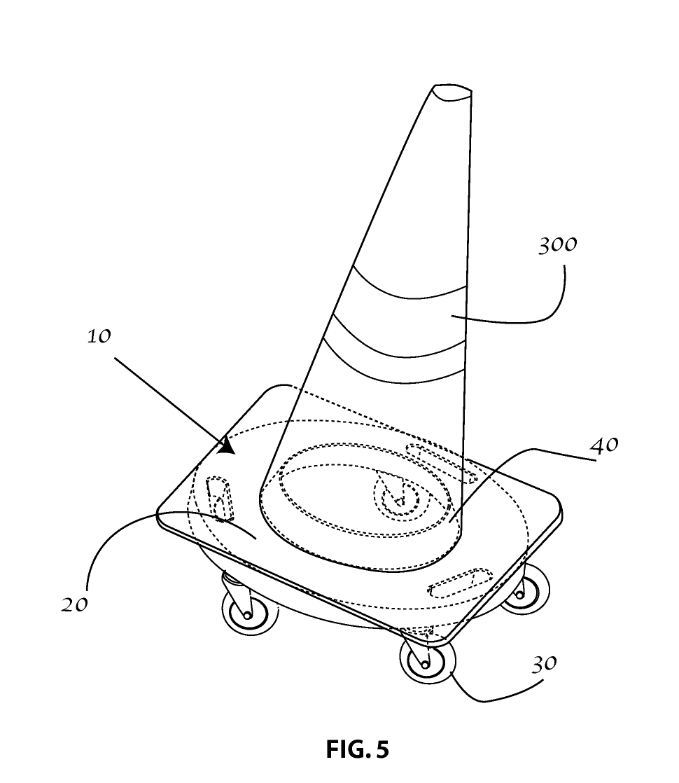

FIG. 5 is an illustration of a perspective view of one embodiment of a traffic cone resting on the traffic cone dolly. As shown in FIG. 5, the multi-wheeled traffic cone dolly 10 has wheels 30, platform 20, and proximally slanted ring shaped protrusion 40, which is centered on platform 20, and which is adapted to engage with traffic cone 300. FIG. 5 shows how multi-wheeled traffic cone dolly 10 provides a stable and rollably movable device to easily and efficiently transport one or more traffic cones. Additional traffic cones are simply stacked on top of the first traffic cone 300. FIG. 5 shows how the proximally slanted ring shaped protrusion 40 centers the traffic cone 30 and prevents the traffic cone 30 from easily sliding off of platform 20.

In summary, the present invention is a dolly that assists a user in moving one or more traffic cones or other hollow conical objects from one location to another. The cone dolly is stackable on top of a traffic cone when it is not in use. To help move the dolly from one location to another while it is not in use, the dolly may contain handles or indentations for a user's hand to firmly grip the dolly. Users can utilize the wheels on the bottom of the dolly to push one or more cones from one location to another or utilize the handles within the body of the dolly to carry the dolly when it is not in use.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A multi-wheeled traffic cone dolly comprising:
a platform;
a plurality of wheels;
wherein said plurality of wheels are on a bottom side of said platform such that said platform is rollably supported by said plurality of wheels;
wherein a top side of said platform has a ring shaped protrusion rising from said top side of said platform; and
wherein an exterior surface of said ring shaped protrusion is adapted to engage with an interior surface of a traffic cone to be transported to enable said traffic cone to be transported to be rollably moved by said multi-wheeled traffic cone dolly.

2. The multi-wheeled traffic cone dolly of claim 1, wherein said platform is further comprised of a hole;
wherein said ring shaped protrusion is proximally slanted;
wherein said proximally slanted ring shaped protrusion rising from said top side of said platform forms a lip that is flush with and encircles said hole; and
wherein said hole and an interior surface of said lip are adapted to matingly engage with an exterior surface of a stationary traffic cone such that said multi-wheeled traffic cone dolly encircles said stationary traffic cone.

3. The multi-wheeled traffic cone dolly of claim 2, wherein said proximally slanted ring shaped protrusion and said hole are substantially at a center of said platform; and
wherein said proximally slanted ring shaped protrusion centers said traffic cone to be transported on said platform.

4. The multi-wheeled traffic cone dolly of claim 3, wherein said platform further comprises one or more handle holes;
wherein said one or more handle holes are adapted for grasping and carrying said traffic cone dolly when not in use.

5. The multi-wheeled traffic cone dolly of claim 4, wherein said interior surface of said lip is comprised of a plurality of protrusions that releasably engage with said exterior surface of said stationary traffic cone when said multi-wheeled traffic cone dolly is placed on and encircles said stationary traffic cone.

6. The multi-wheeled dolly of claim 5, wherein said plurality of wheels are adapted to roll over uneven and rough terrain.

7. The multi-wheeled traffic cone dolly of claim 6, wherein said platform is substantially circular.

8. The multi-wheeled traffic cone dolly of claim 7, wherein said multi-wheeled traffic cone dolly is stored by stacking said multi-wheeled traffic cone dolly on top of said stationary traffic cone.

9. The multi-wheeled traffic cone dolly of claim 3, wherein said multi-wheeled traffic cone dolly is stored by stacking said multi-wheeled traffic cone dolly on top of said stationary traffic cone.

10. A multi-wheeled traffic cone dolly comprising:
a substantially circular platform;
a plurality of wheels;
wherein said plurality of wheels are on a bottom side of said platform such that said platform is rollably supported by said plurality of wheels;
wherein said platform is comprised of a centralized hole and one or more handle holes;
wherein a top side of said platform has a proximally slanted ring shaped lip rising from said top side of said platform;
wherein said proximally slanted ring shaped lip is flush with and encircles said centralized hole;
wherein said centralized hole and an interior surface of said lip are adapted to matingly engage with an exterior surface of a stationary traffic cone when said multi-wheeled traffic cone dolly is placed on and encircles said stationary traffic cone;
wherein an exterior surface of said proximally slanted ring shaped lip is adapted to engage with an interior surface of a traffic cone to be transported to enable said traffic cone to be transported to be centered on said platform and rollably moved by said multi-wheeled traffic cone dolly;
wherein said one or more handle holes are adapted for grasping and carrying said traffic cone dolly when not in use.

11. The multi-wheeled traffic cone dolly of claim 10, wherein said interior surface of said lip is comprised of a plurality of protrusions that releasably engage with said exterior surface of said stationary traffic cone when said multi-wheeled traffic cone dolly is placed on and encircles said stationary traffic cone.

12. The multi-wheeled traffic cone dolly of claim 10, wherein said plurality of wheels are adapted to roll over uneven and rough terrain.

13. The multi-wheeled traffic cone dolly of claim 10, wherein said plurality of wheels are arched to reduce a wheel surface area that makes contact with the ground.

14. The multi-wheeled traffic cone dolly of claim 10, wherein said multi-wheeled traffic cone dolly is stored by being stacked on top of said stationary traffic cone.
